(19) United States
(12) Patent Application Publication
(10) Pub. No.: US 2025/0198789 A1
(43) Pub. Date: Jun. 19, 2025

(54) DRIVING INFORMATION DISPLAY APPARATUS AND METHOD FOR PROVIDING CHARGING GUIDANCE INFORMATION FOR ELECTRIC VEHICLE

(71) Applicants: Hyundai Motor Company, Seoul (KR); Kia Corporation, Seoul (KR); Hyundai Autoever Corp., Seoul (KR)

(72) Inventors: Sang Jun Lee, Gwangju (KR); Jaeseok Park, Hwaseong-si (KR); Geumdan Jin, Hwaseong-si (KR); Taehyun Sung, Seoul (KR); Hanshik Kim, Hwaseong-si (KR); Tae Heon Kim, Hwaseong-si (KR); WonMi Ahn, Seoul (KR); Jin Young Min, Seoul (KR); HwaHyeon Hong, Seoul (KR); Lam Lee, Seoul (KR)

(21) Appl. No.: 18/965,120

(22) Filed: Dec. 2, 2024

(30) Foreign Application Priority Data
Dec. 18, 2023 (KR) 10-2023-0184066

(51) Int. Cl. G01C 21/36; B60L 58/12; G07C 5/08

(52) U.S. Cl. CPC G01C 21/3697; B60L 58/12; G01C 21/3679; G07C 5/085

(57) ABSTRACT

In a driving information display apparatus and method for providing charging guidance information for an electric vehicle, the driving information display apparatus can include a processor configured to perform control to receive driving guidance information and the location information of an electric vehicle and output a guidance screen corresponding to the driving guidance information, and a storage unit configured to store road information and an algorithm run by the processor. The driving guidance information can include charging guidance information intended to prevent the battery charge level of the electric vehicle from being lower than a target remaining battery charge level generated based on the internal and external state information of the electric vehicle and information related to a current driver.

### CROSS-REFERENCE TO RELATED APPLICATIONS

The present application claims priority to Korean Patent Application No. 10-2023-0184066 filed on Dec. 18, 2023, the entire contents of which are incorporated herein for all purposes by this reference.

### TECHNICAL FIELD

The present disclosure relates to a driving information display apparatus and method for providing charging guidance information for an electric vehicle.

### BACKGROUND

Electric vehicles may be difficult to drive comfortably due to long charging times and an insufficient number of charging stations in terms of the characteristics thereof. Accordingly, there is a demand for a route guidance service that considers the battery states of electric vehicles and guides them to charging stations.

In response to the demand, there is disclosed a technology that changes a guidance route by considering a remaining battery charge level at each location while guiding an electric vehicle through the guidance route, such as the technology disclosed in U.S. Pat. No. 9,170,118 entitled “Navigation System for Electric Vehicle.” In this technology, to ensure safe next driving when the electric vehicle arrives at a destination, a target remaining battery charge level at the destination is set, and route guidance used for driving via a charging station is provided to achieve the target remaining battery charge level.

However, when a target remaining battery charge level at a destination is fixed without considering a driving environment, comfortable driving may be interrupted due to an unnecessary stop at a charging station, so that a charging guidance method appropriate to a situation is required.

The information included in this Background of the Present Disclosure is only for enhancement of understanding of the general background of the present disclosure and may not be taken as an acknowledgement or any form of suggestion that this information forms the prior art already publicly known, available, or in use.

### SUMMARY

The present disclosure relates to a driving information display apparatus and method for providing charging guidance information for an electric vehicle, and more particularly to an apparatus for displaying driving guidance information that enables comfortable driving to a destination by considering the battery state of an electric vehicle, and a method of operating the same.

An embodiment of the present disclosure can provide driving guidance information that enables comfortable driving by considering the remaining battery charge level of an electric vehicle.

An embodiment of the present disclosure can provide driving guidance information appropriate to a situation by determining a target remaining battery charge level in accordance with the situation by using the internal and external information of an electric vehicle.

An embodiment of the present disclosure can provide driver-customized driving guidance information by determining a target remaining battery charge level through the consideration of a driver's tendencies.

An embodiment of the present disclosure can provide driving guidance information appropriate to a situation even when driver information is not sufficiently accumulated.

The problems to be solved as an example embodiment of the present disclosure are not necessarily limited to the problems described above, and solutions to other problems by an embodiment of the present disclosure may be understood by those skilled in the art from the following detailed description of example embodiments of the present disclosure.

According to various embodiments of the present disclosure, a driving information display apparatus can include: a processor configured to perform control to receive driving guidance information and the location information of an electric vehicle and output a guidance screen corresponding to the driving guidance information; and a storage unit configured to store road information and an algorithm run by the processor, and the driving guidance information can include charging guidance information intended to prevent the battery charge level of the electric vehicle from being lower than a target remaining battery charge level generated based on the internal and external state information of the electric vehicle and information related to a current driver.

The target remaining battery charge level may be generated based on information obtained by entering the internal and external state information into a per-driver artificial intelligence model that is generated by training on a driver charging information database that records internal and external state information and the amount of electricity charged whenever the current driver charged the electric vehicle in the past.

When the per-driver artificial intelligence model has not been generated, the target remaining battery charge level may be generated based on information obtained by entering the internal and external state information into a general artificial intelligence model that is generated by training on a general charging information database that records internal and external state information and the amount of electricity charged whenever each of all drivers charged his or her electric vehicle in the past.

The internal and external state information may include: the normalized value of the number of charging stations within a predetermined distance from a destination; information related to the fatigue of the driver generated based on an image from an internal camera of the electric vehicle; information related to a preferred charging station generated based on the brand information of a charging station used by the driver of the electric vehicle; information related to the incident facilities of a charging station generated based on information related to whether the incident facilities of a charging station used by the driver of the electric vehicle were used by the driver of the electric vehicle; weather information.

According to various embodiments of the present disclosure, a driving information management server can be equipped with a central processing unit and memory, and the driving information management server can include: a connection setup unit configured to set up connections to exchange information with the driving information display apparatuses of a plurality of electric vehicles; an information reception unit configured to receive the internal and external state information and current driver information of each of the electric vehicles from the electric vehicle; and an information transmission unit configured to obtain a target remaining battery charge level based on the internal and external state information and current driver information of the electric vehicle and transmit charging guidance information, generated using the target remaining battery charge level, to the electric vehicle.

The driving information management server may further include an information storage unit configured to, when the electric vehicle is charged, receive the internal and external state information and current driver information of the electric vehicle and store them in a driver charging information database for each driver, and the information transmission unit may obtain the target remaining battery charge level based on the information obtained by entering the internal and external state information into a per-driver artificial intelligence model that is generated by training on the information of the driver charging information database corresponding to the current driver.

The information storage unit may store the received information in a general charging information database that stores information of all drivers in an integrated manner, and the information transmission unit, when the per-driver artificial intelligence model has not been generated, may obtain the target remaining battery charge level based on the information obtained by entering the internal and external state information into a general artificial intelligence model that is generated by training on the general charging information database.

The methods and apparatuses of embodiments of the present disclosure can have other features and advantages that can be apparent from or can be set forth in more detail in the accompanying drawings, which are incorporated herein, and the following Detailed Description, which together serve to explain certain principles of example embodiments of the present disclosure.

### BRIEF DESCRIPTION OF THE DRAWINGS

FIG. 1 is a block diagram showing the internal configuration of a driving information display device according to various example embodiments of the present disclosure;

FIG. 2 is a block diagram showing the internal configuration of a driving information management server according to various example embodiments of the present disclosure;

FIG. 3 is a diagram showing an example of route guidance based on a target remaining battery charge level in a driving information display apparatus according to various example embodiments of the present disclosure;

FIG. 4 is a diagram showing a process of generating charging guidance information by using an artificial intelligence model in a driving information display apparatus according to various example embodiments of the present disclosure;

FIG. 5 is a diagram showing an example of an artificial intelligence model used in a driving information display apparatus according to various example embodiments of the present disclosure;

FIG. 6 is a flowchart showing the flow of a driving information display method according to various example embodiments of the present disclosure; and

FIG. 7 is a flowchart showing the flow of a driving information management method according to various example embodiments of the present disclosure.

It may be understood that the appended drawings are not necessarily to scale, presenting a somewhat simplified representation of various features illustrative of the basic principles of the example embodiments of the present disclosure. The specific design features of example embodiments of the present disclosure as included herein, including, for example, specific dimensions, orientations, locations, and shapes can be determined in part by the particularly intended application and use environment.

In the figures, reference numbers can refer to same or equivalent parts of example embodiments of the present disclosure throughout the several figures of the drawing.

### DETAILED DESCRIPTION OF ILLUSTRATIVE EMBODIMENTS

Reference will now be made in detail to various example embodiments of the present disclosure, which are illustrated in the accompanying drawings and described below. While the present disclosure will be described in conjunction with example embodiments of the present disclosure, it can be understood that the present description is not intended to necessarily limit the present disclosure to those example embodiments of the present disclosure. On the other hand, the present disclosure is intended to cover not only the example embodiments of the present disclosure, but also various alternatives, modifications, equivalents and other embodiments, which may be included within the spirit and scopes of the present disclosure as defined by the appended claims.

Example embodiments of the present disclosure will be described in detail below with reference to the accompanying drawings. In the following description of example embodiments of the present disclosure, when it is determined that a detailed description of any related known configuration or function may obscure the gist of the present disclosure, the detailed description can be omitted. In the following description of the example embodiments of the present disclosure, specific numerical values are only examples, and the scope of the present disclosure is not necessarily limited thereby.

In the following descriptions of the components of the example embodiments of the present disclosure, terms such as “first,” “second,” “A,” “B,” “(a),” “(b),” and so forth, may be used. These terms can be used merely to distinguish corresponding components from other components, and the natures, sequential positions, and/or orders of the corresponding components are not necessarily limited by these terms. Unless defined otherwise, terms used herein, including technical or scientific terms, can include a same meaning as commonly understood by those skilled in the art to which an example embodiment of the present disclosure pertains. Terms such as those defined in commonly used dictionaries can be interpreted as having meanings consistent with the meanings in the context of related art, and should not be interpreted as having ideal or excessively formal meanings unless explicitly defined in the present application.

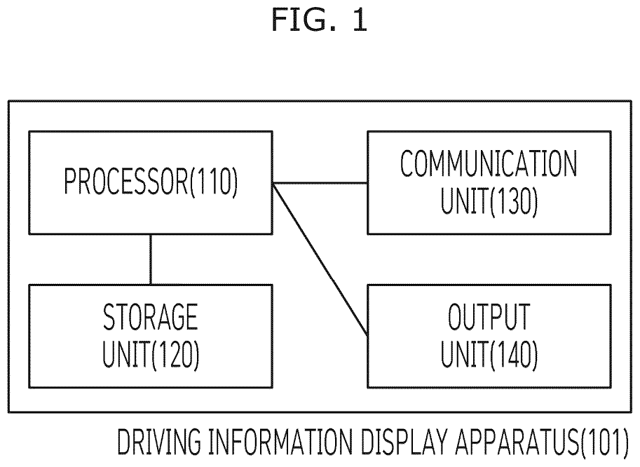

Example embodiments of the present disclosure will be described in detail below with reference to FIGS. 1 to 7.

FIG. 1 is a block diagram showing the internal configuration of a driving information display apparatus 101 according to various example embodiments of the present disclosure.

The driving information display apparatus 101 according to the example embodiment may be provided inside a transportation system such as a vehicle, or may be implemented in a detachable form. The driving information display apparatus 101 may generally include the form of a vehicle navigation system, an audio, video and navigation (AVN) system, a head-up display (HUD), or the like, and may be implemented in a form in which an application is provided on a mobile phone terminal such as a smartphone, for example.

The driving information display apparatus 101 according to the example embodiment may be present in a form of a server outside a transportation system, such as a vehicle. The driving information display apparatus 101 may be implemented to generate driving guidance information by processing determinations while being present outside a transportation system and to output the driving guidance information to a display present inside the transportation system. Various embodiments may be implemented. The scope of rights of the present disclosure is not necessarily limited by the forms of such implementations.

The driving information display apparatus 101 of the example embodiment may operate in conjunction with devices for autonomous driving control such as an advanced driver assistance system (ADAS), a smart cruise control (SCC) system, a forward collision warning (FCW) system, and/or the like.

As shown in the drawing, the driving information display apparatus 101 according to the example embodiment may include a processor 110, a storage unit 120, a communication unit 130, and an output unit 140.

The processor 110 can be configured to control the storage unit 120, the communication unit 130, and the output unit 140 to execute an application, process data according to the algorithm defined in the application, communicate with an external module, and provide the results of the processing to a user.

The processor 110 may refer to a chip for processing a general algorithm, such as a central processing unit (CPU) or an application processor (AP), or a set of such chips. The processor 110 may refer to a chip optimized for floating-point arithmetic, such as a general-purpose computing on graphics processing unit (GPGPU), to process an artificial intelligence algorithm such as deep learning, or a set of such chips. Alternatively, the processor 110 may refer to a module in which various types of chips perform an algorithm and process data in a connected and distributed manner.

The processor 110 may be electrically connected to the storage unit 120 (storage medium) and the communication unit 130, may electrically control the individual components, may be an electric circuit that executes software commands, and may perform various types of data processing and determination to be described later. The processor 110 may be, for example, an electronic control unit (ECU), a micro-controller unit (MCU), or another lower level controller that is mounted on a transportation system.

The storage unit 120 can be a storage medium that can store road information and an algorithm executed by the processor. The road information may include map information, road traffic condition information, and/or the like. Depending on the configuration of the driving information display apparatus 101 of the present disclosure, the form or amount of road information stored inside the driving information display apparatus 101 may vary.

In some cases, the storage unit 120 may store road information including the map information and traffic condition information of all serviceable areas and provide services based on the road information. Alternatively, the storage unit 120 may temporarily store only road information related to a location where guidance is being made and provide services based on the temporarily stored road information.

This may be implemented as a different form depending on the form in which the driving information display apparatus 101 according to an example embodiment of the present disclosure is implemented inside or outside a transportation system, the communication method used, the storage space of the storage unit 120, and/or input/output speed. This is a part that may be chosen autonomously by those skilled in the art depending on the implementation situation. The scope of rights of the present disclosure is not necessarily limited by such changes in implementations.

The road information stored in the storage unit 120 may include not only general road information but also information related to the locations, capacities, and numbers of chargers of electric charging stations for the charging of electric vehicles. Based on these types of information, driving information guidance that considers the charging situation may be provided.

The road information stored in the storage unit 120 may include various types of display information to be displayed in guidance information. The display information may include various types of information to be included in the guidance information displayed in driving situations, such as intersections, traffic lights, crosswalks, destinations, and major landmarks. The display information included in the road information may include parking locations, entrance locations, ramps for movement between floors, indoor facilities, road information outside indoor sections connected to exits, and/or the like for the purpose of guidance inside indoor sections. Such display information may each be composed of a combination of the name of the display information to be displayed as guidance information and information related to the location where the corresponding display information can be displayed.

The storage unit 120 may have various forms, and may be at least one type of storage medium such as a flash memory-, hard disk-, micro-, card (e.g., secure digital (SD) card)-, extreme digital (XD) card-, random access memory (RAM)-, static RAM (SRAM)-, read-only memory (ROM)-, programmable ROM (PROM)-, electrically erasable PROM (EPROM)-, magnetic memory (MRAM)-, magnetic disk-, or optical disk-type storage medium, or the like. Depending on the amount, processing speed, storage time, and/or the like of data to be stored, a different type of storage medium or a combination of different types of storage media may be chosen.

The algorithm stored in the storage unit 120 may be implemented as a computer program in an executable form, and may be implemented to be stored in the storage unit 120 and then executed in a required situation. The algorithm stored in the storage unit 120 may be interpreted as including an instruction form that is temporarily loaded into volatile memory and instructs the processor to perform specific operations.

The communication unit 130 can receive information for driving guidance from the outside of the driving information display apparatus 101 of the present disclosure over a wired/wireless communication network, and transmit necessary information to an external module.

The communication unit 130 may receive road information stored in the storage unit 120, an algorithm executed by the processor 110, and the like from an external module, and may transmit information related to the current state of a transportation system to the outside to obtain necessary information related to the transmitted information. For example, the communication unit 130 may continuously receive traffic information from a traffic information server to check real-time traffic information, and can be configured to transmit the location and route information of a transportation system, found through a module such as a Global Positioning System (GPS) receiver, to the outside to obtain the real-time traffic information of an area related to the location and route of the transportation system.

The communication unit 130 may be configured to transmit the internal and external information of a vehicle and receive information required for driving guidance while communicating with a driving information management server 201 that can process and provide information required for driving information guidance.

The communication unit 130 can be a hardware device that is implemented using various electronic circuits to transmit and receive signals over a wireless or wired connection. In an example embodiment of the present disclosure, the communication unit 130 may perform communication within a transportation system using infra-transportation system network communication technology, and may perform Vehicle-to-Infrastructure (V2I) communication with a server, infrastructure, another transportation system, and/or the like outside a transportation system using wireless Internet access or short-range communication technology. The communication within a transportation system may be performed using Controller Area Network (CAN) communication, Local Interconnect Network (LIN) communication, FlexRay communication, and/or the like as the infra-transportation system network communication technology. Such wireless communication technology may include wireless LAN (WLAN), Wireless Broadband (WiBro), Wi-Fi, Worldwide Interoperability for Microwave Access (WiMAX), etc. The short-range communication technology may include Bluetooth, ZigBee, Ultra-wideband (UWB), Radio Frequency Identification (RFID), Infrared Data Association (IrDA), etc.

The output unit 140 may output augmented reality information that is controlled by executing the algorithm, stored in the storage unit 120, by the processor 110. Augmented reality is a technology for enabling related information to be provided by adding graphic information to an image or scene of the real world.

The output unit 140 may be implemented as a head-up display (HUD), a cluster, an audio, video and navigation (AVN) system, a human-machine interface (HMI), and/or the like. The output unit 140 may include at least one of a liquid crystal display (LCD), a thin film transistor liquid crystal display (TFT LCD), a light emitting diode (LED) display, an organic light emitting diode (OLED) display, an active matrix OLED (AMOLED) display, a flexible display, a bended display, and a three-dimensional (3D) display. Some of these displays may be implemented as a transparent display configured in a transparent or translucent form to be able to view the outside thereof. The output unit 140 may be provided as a touch screen including a touch panel, and may be used as an input device as well as an output device.

In an embodiment of the present disclosure, the vehicle may be described as being based on a concept including various transportation systems. In some cases, the vehicle may be interpreted as being based on a concept including not only various land transportation systems, such as cars, motorcycles, trucks, and buses, which drive on roads, but also various transportation systems, such as airplanes, drones, ships, etc.

Accordingly, in an embodiment of the present disclosure, the electric vehicle may be interpreted as being based on a concept including various transportation systems that store electric energy in a secondary battery and use it as a power source among various transportation systems.

The driving information display apparatus 101 according to an embodiment of the present disclosure may have different example embodiments depending on the driving guidance information processed by the processor 110. Accordingly, the generation of the driving guidance information received by the processor 110 and the information included in the driving guidance information will be described by way of example below.

As described above, the processor 110 can perform control to receive driving guidance information and information related to the location of an electric vehicle and output a guidance screen corresponding to the driving guidance information. The driving guidance information may include a variety of types of information. When a driver sets a destination and wants to receive guidance information related to it through a screen, the driving guidance information may include information related to the destination and a route leading to the destination. Various types of other information for the driving guidance of a vehicle may be included in the driving guidance information.

In particular, in the case of an electric vehicle, the driving distance is short, charging takes a long time, and there are not a sufficient number of charging stations, so that it is important to provide guidance on an optimal route passing through a charging station during route guidance. Accordingly, the processor 110 may be configured to provide guidance on an optimal route along which a driver may safely drive to a destination while charging an electric vehicle at a necessary point by using electric vehicle charging station information included in the map information stored in the storage unit 120.

The driving guidance information may be information received from a driving information management server 102 through the communication unit 130, or may be information derived by the processor 110 through its own computation process. The driving guidance information may include charging guidance information that provides guidance on a charging station, through which a driver passes when driving an electric vehicle to a destination, and the amount of electricity required for charging at the charging station.

The processor 110 may obtain or generate the internal and external state information of the electric vehicle and identify information related to the driver who currently drives the electric vehicle. The charging guidance information may be generated by considering the state of the electric vehicle and the driver's tendencies using the internal and external state information of the electric vehicle and the information related to the current driver, and may thus can be provided as customized information.

In particular, in the case of an electric vehicle, a remaining battery charge level needs to be maintained at a predetermined value or higher when the electric vehicle arrives at a destination or charging station. Accordingly, the processor 110 may determine an expected remaining battery charge level when arriving at the destination or charging station by considering the driving distance to the destination or charging station, road conditions, and/or the like, and may provide the driver with driving guidance information including charging guidance information that provides guidance on preventing the determined value from falling below a target remaining battery charge level.

The target remaining battery charge level may not be a fixed value, but may be determined by considering the internal and external state information of the electric vehicle and the information related to the current driver as described above. Accordingly, there may be provided customized guidance that considers the driving situation and the driver's tendencies.

For example, when the driver has a tendency to maintain a higher remaining battery charge level at a destination, the target remaining battery charge level may be set to a higher value than that for other drivers. When the current weather is rainy, the target remaining battery charge level may be set to a higher value than usual for the purpose of safe driving.

When the target remaining battery charge level is set to a higher value, there may be provided guidance on increasing the amount of electricity to be charged at a charging station during a drive to a destination, compared to when the target remaining battery charge level is set to a lower value. In the opposite case, the driver can be guided to charge only a small amount of electricity and start driving again rapidly. Accordingly, charging guidance information appropriate to the situation may be provided.

To generate charging guidance information appropriate to the situation, the target remaining battery charge level may be generated based on the information obtained by entering the internal and external state information into a per-driver artificial intelligence model generated by training on a driver charging information database that records internal and external state information and the amount of electricity charged whenever the current driver charged the vehicle in the past.

The artificial intelligence model such as a machine learning model can be generated by training using various types of contextual training data. When a new situation is entered into the generated artificial intelligence model, determination results for the situation may be provided.

In an embodiment of the present disclosure, when each driver visits a charging station to charge an electric vehicle, the internal and external state information of the electric vehicle and the amount of electricity actually charged by the driver are accumulated and stored in the driver charging information database, and an artificial intelligence model can be generated using the data of the driver charging information database as training data. By doing so, when the driver needs to charge the electric vehicle again, the amount of electricity to be charged may be generated as a result value.

When a driver charging information database is stored separately for each driver by using driver information, a per-driver artificial intelligence model can be generated for each driver. When new environmental information is entered into the per-drive artificial intelligence model, results that reflect the driver's usual tendencies herein may be obtained.

When the per-driver artificial intelligence model has not been generated, the target remaining battery charge level may be generated based on the information obtained by entering the internal and external state information into a general artificial intelligence model generated by training on a general charging information database that records internal and external state information and the amount of electricity charged whenever each of all drivers charged his or her vehicle in the past.

To train an artificial intelligence model, a minimum amount of training data can be required for training. When a reference amount of data has not yet been accumulated, it may be impossible to generate a per-driver artificial intelligence model. When a per-driver artificial intelligence model has not been generated because training data is insufficient, charging guidance information may be generated based on a general driver's tendencies by storing the information of all drivers in a general charging information database and using a general artificial intelligence model generated based on the general charging information database.

The minimum amount of training data for training can vary depending on an algorithm used to generate the artificial intelligence model.

When information related to the amount of electricity required to be charged in a current situation is obtained through the artificial intelligence model, a target remaining battery charge level when a driver arrives at a destination may be calculated. For example, when, in the state in which the current remaining battery charge level of an electric vehicle is 45%, the result value of the per-driver artificial intelligence model indicating that electricity equivalent to 20% of a total battery capacity needs to be charged at a nearby charging station can be obtained and it can be predicted that electricity equivalent to 15% of the total battery capacity will be consumed to drive from the corresponding charging state to a destination, the target remaining battery charge level can be 50% when a driver arrives at the destination.

When the driver charges electricity equivalent to 20% of the total battery capacity at the charging station according to the charging information displayed, the electric vehicle may arrive at the destination with the remaining battery charge level being 50%.

The range in which the remaining battery charge level of the electric vehicle can be 30% to 70% is a stable battery output region (a plateau). Accordingly, it can be desirable that the remaining battery charge level when an electric vehicle arrives at a destination is within the range of 30% to 70%. When the target remaining battery charge level calculated by considering the internal and external state information of the electric vehicle and information related to a current driver is lower than 30% or higher than 70%, an adjustment may be made so that the target remaining battery charge level can fall within the range of 30% to 70%.

For example, when the target remaining battery charge level, calculated based on the amount of electricity to be charged, which can be obtained by the per-driver artificial intelligence model, is 20%, it can be desirable to generate charging guidance information instructing the driver to charge the electric vehicle with an amount of electricity larger than the amount of electricity to be charged, which can be obtained by the per-driver artificial intelligence model, at the charging station so that the target remaining battery charge level can become 30%.

A variety of artificial intelligence algorithms may be used to generate the per-driver artificial intelligence model and the general artificial intelligence model. A regression algorithm such as a random forest regressor and a neural network such as deep learning may be used. The present disclosure is not necessarily limited to a specific artificial intelligence algorithm.

The internal and external state information of an electric vehicle may include information related to charging stations around a destination, information related to the fatigue of a driver, information related to a preferred charging station, information related to the incidental facilities of the charging stations, weather information, and/or the like, for example.

The information related to charging stations around a destination may include the normalized value of the number of charging stations within a predetermined distance from the destination. When this information is utilized, the results may reflect therein the driver's current tendency related to the amount of electricity charged depending on whether there are a sufficient number of charging stations around the destination.

The information related to the fatigue of a driver may be generated based on an image from the internal camera of the electric vehicle. By analyzing the image from the internal camera, the driver's fatigue level may be generated on a 1-10 scale by using a real-time anomaly detection model. When the information related to the fatigue of a driver is utilized, the results may reflect therein the current driver's tendency to set the amount of electricity to be charged differently depending on his or her fatigue in the past.

The information related to a preferred charging station may be set based on statistical information related to charging stations or charging station brands that the current driver used in the past in such a manner that a top charging station having a high usage rate can be set as a preferred charging station to have a value of 1 and other charging stations can be set as non-preferred charging stations to have a values of 0. When the information related to a preferred charging station is utilized, the results may reflect therein the tendency to set the amount of electricity to be charged differently depending on whether a current charging station is a preferred charging station.

The information related to the incidental facilities of the charging stations may be quantified by calculating the utilization rates of the incidental facilities by using payment information at the incident facilities of charging stations that the current driver visited in the past. When the information related to the incidental facilities of the charging stations is utilized, the results reflect therein the user's tendency to set the amount of electricity to be charged differently depending on the incident facilities of the charging stations.

The weather information may be the weather information of an area where the electric vehicle is currently located, which can be received through the communication unit 130, or may be information obtained by analyzing the use of the washer fluid of the vehicle, the use of the wiper of the vehicle, the measurement results of a rain sensor, and/or the like. When the weather information is utilized, the results may reflect therein the driver's tendency to set the amount of electricity differently depending on the weather.

The internal and external state information of the electric vehicle may include various types of data used to determine the driver's tendencies. It can be desirable that the internal and external state information of the electric vehicle include numerical data that is used as input data to train the artificial intelligence model.

Although the charging guidance information may be generated by a direct operation in the processor 110, it can be preferable that the charging guidance information be calculated by the driving information management server 201 and transmitted to the communication unit 130 to smoothly run the artificial intelligence model.

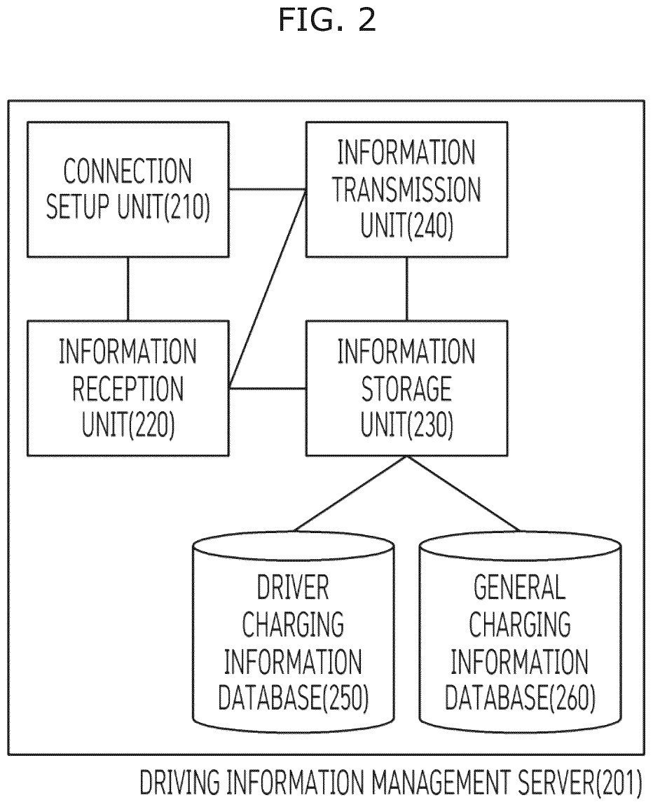

FIG. 2 is a block diagram showing the internal configuration of a driving information management server according to various example embodiments of the present disclosure.

The driving information management server 201 according to various example embodiments of the present disclosure can be a server equipped with a central processing unit (CPU) and memory, and may include a standalone server or a cloud. The configuration of the driving information management server 201 is not limited as long as the driving information management server 201 can obtain a target remaining battery charge level by processing the information received from the above-described driving information display apparatus 101 over a wired or wireless communication network and transmit the target remaining battery charge level back to the driving information display apparatus 101 over a communication network.

The driving information management server 201 of an embodiment of the present disclosure can process the operation required to generate the charging guidance information displayed on the driving information display apparatus 101. Accordingly, the process of generating charging guidance information in the driving information display apparatus 101 described above may be performed in the driving information management server 201. Therefore, the description of the process of generating charging guidance information displayed on the driving information display apparatus 101 may be applied to the driving information management server 201 without significant change.

As shown in the drawing, the driving information management server 201 may include a connection setup unit 210, an information reception unit 220, an information storage unit 230, an information transmission unit 240, a driver charging information database 250, and a general charging information database 260, any of, any combination of, or all of which may be in plural or may include plural components thereof.

The connection setup unit 210 can set up connections to exchange information with the driving information display apparatuses 101 of a plurality of electric vehicles. The connection setup unit 210 can set up connections with the communication units 130 of the driving information display apparatuses 101 over a wired or wireless communication network, and is not limited to a specific type of communication.

The information reception unit 220 can receive internal and external state information of an electric vehicle, information related to a current driver, and information related to a destination from the driving information display apparatus 101. As described above, to derive a target remaining battery charge level via an artificial intelligence model, the internal and external state information of an electric vehicle, information related to a current driver, and information related to a destination can be required. Because these pieces of information are information generated by the driving information display apparatus 101 of the electric vehicle, these pieces of information can be received over the connections set up by the connection setup unit 210.

When the electric vehicle is charged, the information storage unit 230 can receive the internal and external state information of the electric vehicle and the information related to a current driver and stores them in the driver charging information database 250 for each driver. The information stored can be stored in association with information related to the amount of electricity actually charged. As described above, data obtained by storing a situation and the amount of electricity charged in the situation whenever the electric vehicle is charged can become training data for generating a per-driver artificial intelligence model, so that the above information can be separated for each driver and stored in a database.

The information storage unit 230 can store the received information in the general charging information database 260 that stores the information of all drivers. As described above, when training data sufficient to generate an artificial intelligence model has not been accumulated because the current driver does not have sufficient past charging history, a target remaining battery charge level can be obtained using a general artificial intelligence model generated by training on the general tendencies of all users. Accordingly, a general artificial intelligence model can be generated by storing the internal and external state information of the electric vehicle and the information related to the current driver when the electric vehicle is charged in the general charging information database 260 regardless of the driver and using these pieces of information as training data. The information stored can be stored in association with information related to the amount of electricity actually charged.

The information transmission unit 240 can obtain a target remaining battery charge level based on the internal and external state information of the electric vehicle and the information related to the current driver and can transmit the target remaining battery charge level to the electric vehicle. As described above, the target remaining battery charge level can be generated based on the information obtained by entering the internal and external state information into a per-driver artificial intelligence model generated by training on the information of the driver charging information database corresponding to the current driver. The per-driver artificial intelligence model can provide the amount of electricity to be charged as a result value when the driver's tendencies are reflected in a charging situation, so that a remaining battery charge level when the driver arrives at the destination can be obtained using the result value, as described above.

When the per-driver artificial intelligence model has not been generated, the information transmission unit 240 can obtain the target remaining battery charge level based on the information obtained by entering the internal and external state information into a general artificial intelligence model generated by training on the general charging information database 260. In the same manner, the target remaining battery charge level can be calculated using the information related to the amount of electricity to be charged at a charging station that can be provided as a result value by the general artificial intelligence model.

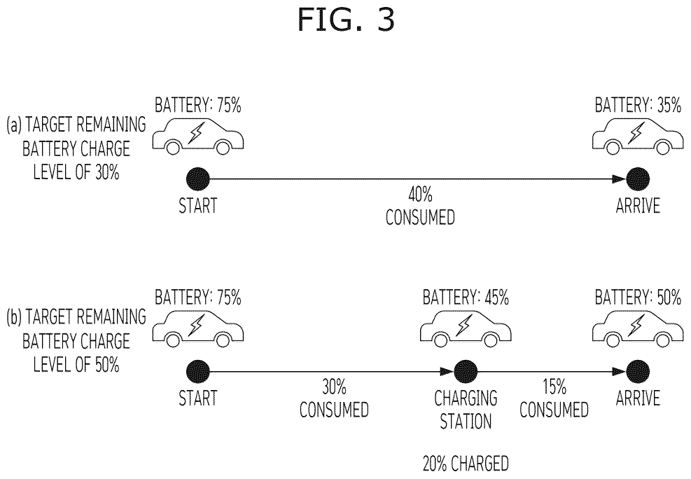

FIG. 3 is a diagram showing an example of route guidance based on a target remaining battery charge level in a driving information display apparatus according to various example embodiments of the present disclosure.

In this example, in the case where 40% of the total battery capacity is consumed when an electric vehicle charged up to 75% of the total battery capacity is driven directly to a destination, route guidance can vary depending on a target remaining battery charge level.

In the case where the electric vehicle arrives to the destination by consuming 40% of the total battery capacity when the electric vehicle has been charged up to 75% of the total battery capacity, the remaining battery charge level can become 35% of the total battery capacity.

Accordingly, when the target remaining battery charge level is set to 30% (case (a) of FIG. 3), the remaining battery charge level expected at the destination can be higher than the target remaining battery charge level, so that the driver can be guided to drive directly to the destination without passing through a charging station.

In contrast, when the target remaining battery charge level is set to 50% (case (b) of FIG. 3), the remaining battery charge level expected at the destination can be lower than the target remaining battery charge level, so that, when the driver arrive at the destination via a charging station, the driver can be guided to maintain a remaining battery charge level equal to the target remaining battery charge level.

In the related art, the target remaining battery charge level is fixed or set by a driver directly, so that route guidance is provided without considering a driving situation or the driver.

When a driver drives an electric vehicle with a target remaining battery charge set to 50%, the driver can be guided to charge the electric vehicle with electricity equivalent to 20% of the total battery capacity at a charging station and move to a destination regardless of the driver or the internal and external state information of the electric vehicle, as shown in case (b) of FIG. 3.

Accordingly, the driver may be guided to charge the electric vehicle at a location other than a preferred charging station, or the driver may be guided to stop by a charging station unnecessarily even when it is determined that a sufficient remaining battery charge level can be maintained at a destination in terms of the driver's tendency, which may cause inconvenience to driving.

Accordingly, in an embodiment of the present disclosure, the target remaining battery charge level can be not set to a fixed value. When logic for driving via a charging station is activated on the route of an electric vehicle, the amount of electricity to be charged at the corresponding charging station can be determined by entering the internal and external state information of the electric vehicle and information related to a current driver into the artificial intelligence model, and a target remaining battery charge level at the destination can be obtained based on these pieces of information. Accordingly, guidance customized for the driver's tendencies or situation may be provided.

For example, in the case where driver A is a driver who charges an electric vehicle with a large amount of electricity at a charging station along his or her route to maintain a higher remaining battery charge level upon arrival even when the same electric vehicle is driven by a different driver, the target remaining battery charge level can be set to a higher value, and thus, driver A can be guided to drive via a charging station, as shown in case (a) of FIG. 3.

In contrast, in the case where driver B has a tendency in which he or she does not frequently charge the electric vehicle at a charging station along his or her route but he or she charges the electric vehicle after arriving at a destination when there are a plurality of charging stations at the destination, a target remaining battery charge level can be set to a lower value, and thus, driver B can be guided to drive directly to the destination without passing through a charging station.

When the target remaining battery charge level is set to reflect each driver's tendencies, the driver may drive comfortably according to his or her usual driving pattern.

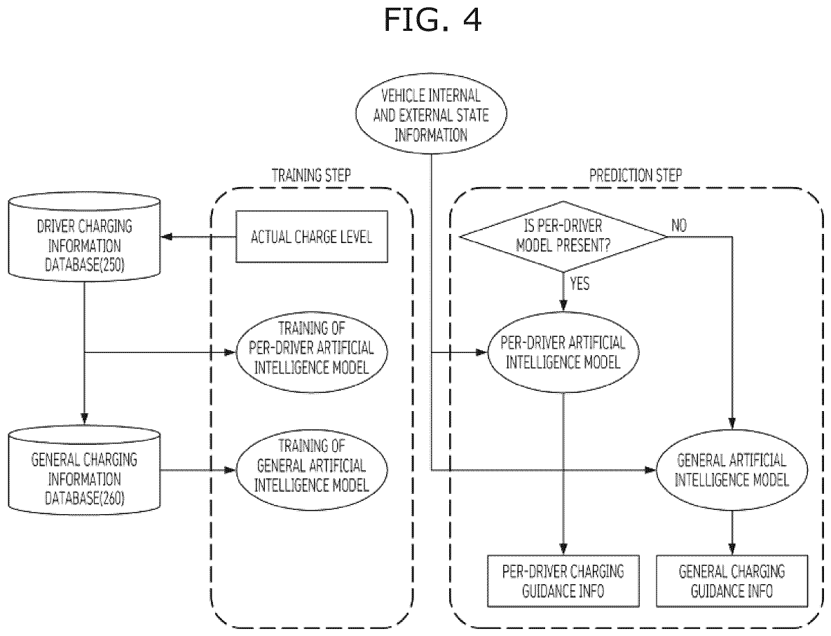

FIG. 4 is a diagram showing a process of generating charging guidance information by using an artificial intelligence model in a driving information display apparatus according to various example embodiments of the present disclosure.

As described above, when a driver charges an electric vehicle with electricity at a charging station, the internal and external state information of the vehicle and information related to the current driver can be identified and stored in the driver charging information database 250. To generate training data, information related to the amount of electricity actually charged can be stored in the driver charging information database 250 in association with the internal and external state information of the vehicle.

The driver charging information database 250 can store the internal and external state information of the vehicle and the information related to the amount of electricity actually charged for each driver, and this information can be also stored in the general charging information database 260. However, the general charging information database 260 can be not separated for each driver and can store information related to all drivers.

In a training step, when the data stored in the driver charging information database 250 has accumulated sufficiently to form training data, a per-driver artificial intelligence model can be generated using the data as training data.

A general artificial intelligence model can be generated by training on the data stored in the general charging information database 260, which can store charging information for all the drivers.

The per-driver artificial intelligence model and the general artificial intelligence model can be configured to be continuously updated as the data accumulates.

Thereafter, when the electric vehicle is actually driven and logic for driving via a charging station on a route is activated, the amount of electricity to be charged at the charging station and a target remaining battery charge level to be set can be determined by considering a current driver's tendencies.

First, information related to the current driver can be identified, and it is determined whether a per-driver artificial intelligence model is present. When a per-driver artificial intelligence model is present, charging guidance information for each driver at the corresponding charging station can be derived by entering the internal and external state information of the vehicle into the per-driver artificial intelligence model generated in the previous training step. The charging guide information can include information related to the amount of electricity to be charged at the corresponding charging station, and the target remaining battery charge level can be determined based on the information related to the amount of electricity to be charged.

When a per-driver artificial intelligence model is not present, general charging guidance information according to the tendencies of general drivers can be generated by entering the internal and external state information of the vehicle into a general artificial intelligence model. The general charging guidance information also can include information related to the amount of electricity to be charged at the corresponding charging station, and the target remaining battery charge amount can be determined based on the information related to the amount of electricity to be charged.

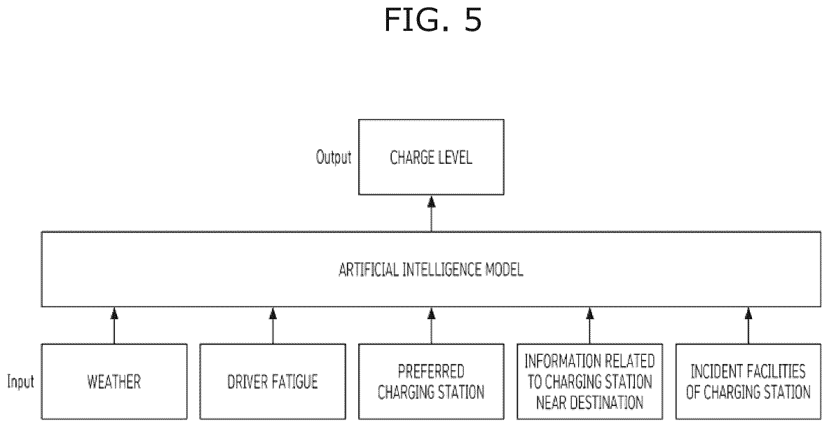

FIG. 5 is a diagram showing an example of an artificial intelligence model used in a driving information display apparatus according to various example embodiments of the present disclosure.

In the present example embodiment, five types of information, i.e., weather, the fatigue of a driver, a preferred charging station, information related to charging stations near a destination, and the incident facilities of the charging stations, can be used as training and input parameters, for example. It can be desirable for each piece of information to be quantified and stored as described above.

In this manner, the artificial intelligence model generated by training on training data having five parameters can provide the amount of electricity to be discharged as an output value when it receives the five parameters as input values.

The per-driver artificial intelligence model and the general artificial intelligence model described above may have the same structure except that different types of training data can be used therein.

When the amount of electricity to be charged, which is output as an output value by the artificial intelligence model, is used, a remaining battery charge level obtained at a destination after a specific amount of electricity has been charged at a charging station may be predicted, and the predicted remaining battery charge level becomes a target remaining battery charge level. The target remaining battery charge level may be set based on results obtained by analyzing the output value of the artificial intelligence model rather than using the output value of the artificial intelligence model without change. For example, as described above, to maintain the target remaining battery charge level within the range of 30% to 70%, in the case where the remaining battery charge level at the destination is lower than 30% or higher than 70% when an amount of electricity equivalent to the output value of the artificial intelligence model is charged, correction may be made.

When the amount of electricity to be charged does not exceed a predetermined reference value, a setting may be made so that the driver is guided to the destination without driving via the corresponding charging station.

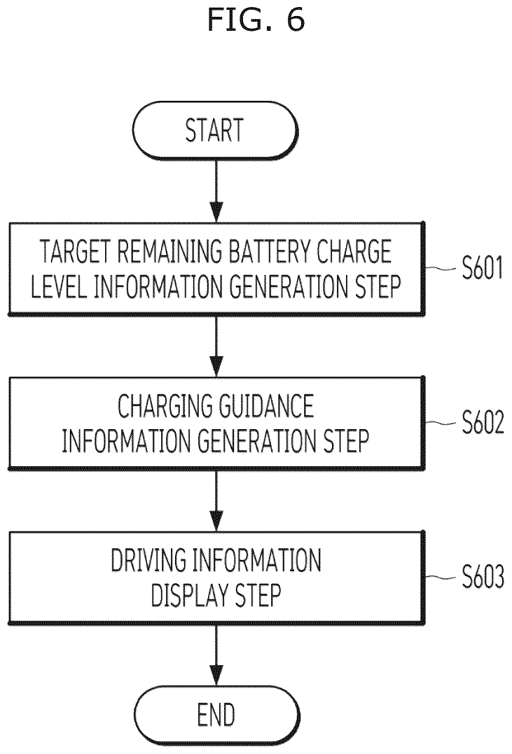

FIG. 6 is a flowchart showing the flow of a driving information display method according to various example embodiments of the present disclosure.

In the present example embodiment, the driving information display method according to the present disclosure is a method that can be performed by the driving information display apparatus 101 including the processor 110 and the storage unit 120. The components described above in conjunction with the operation of the driving information display apparatus 101 may be applied to the driving information display method without significant change. Accordingly, those skilled in the art may implement even the components for which there are no specific descriptions in conjunction with the driving information display method below by applying the foregoing description of the driving information display apparatus 101.

In a target remaining battery charge level information generation step S601, information related to a target remaining battery charge level can be generated based on the internal and external state information of an electric vehicle and information related to a current driver.

In a charging guidance information generation step S602, there can be generated charging guidance information intended to prevent the battery charge level of the electric vehicle from being lower than the generated target remaining battery charge level.

In a driving information display step S603, driving information including the generated charging guidance information can be displayed.

The target remaining battery charge level can be generated based on the information obtained by entering the internal and external state information into a per-driver artificial intelligence model generated by training on a driver charging information database that records internal and external state information and the amount of electricity charged whenever the current driver charged the vehicle in the past.

When the per-driver artificial intelligence model has not been generated, the target remaining battery charge level can be generated based on the information obtained by entering the internal and external state information into a general artificial intelligence model generated by training on a general charging information database that records internal and external state information and the amount of electricity charged whenever each of all drivers charged his or her vehicle in the past.

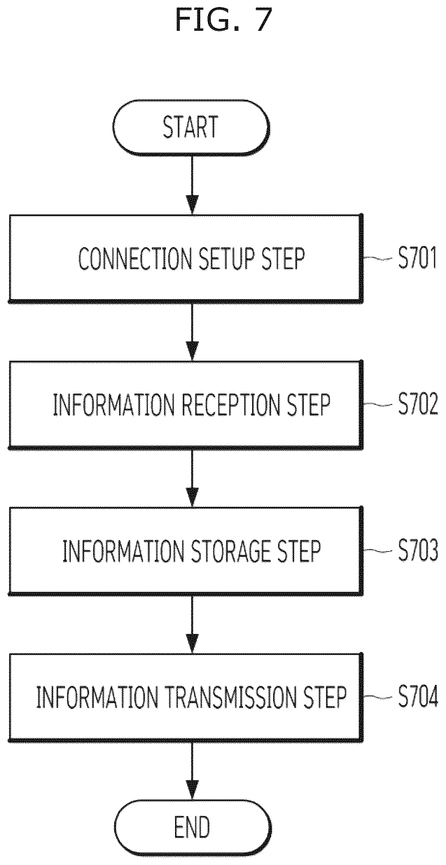

FIG. 7 is a flowchart showing the flow of a driving information management method according to various example embodiments of the present disclosure.

In the present example embodiment, the driving information management method according to the present disclosure is a method that can be performed by the driving information management server 201 including the CPU and the memory. The components described above in conjunction with the operation of the driving information management server 201 may be applied to the driving information management method without significant change. Accordingly, those skilled in the art may implement even the components for which there are no specific descriptions in conjunction with the driving information management method below by applying the foregoing description of the driving information management server 201.

In a connection setup step S701, connections can be set up to exchange information with the driving information display apparatuses of a plurality of electric vehicles.

In an information reception step S702, the internal and external state information and current driver information of each of the electric vehicles can be received from the electric vehicle.

In an information storage step S703, when the electric vehicle is charged, the internal and external state information and current driver information of the electric vehicle can be received and stored in the driver charging information database 250 for each driver.

In the information storage step S703, the received information can be also stored in the general charging information database 260 that stores the information of all drivers.

In an information transmission step S704, a target remaining battery charge level can be obtained based on the internal and external state information and current driver information of the electric vehicle, and charging guidance information generated using the target remaining battery charge level can be transmitted to the electric vehicle.

In the information transmission step S704, the target remaining battery charge level can be generated based on the information obtained by entering the internal and external state information into a per-driver artificial intelligence model generated by training on the information of the driver charging information database corresponding to the current driver. When the per-driver artificial intelligence model has not been generated, the target remaining battery charge level can be obtained based on the information obtained by entering the internal and external state information into a general artificial intelligence model generated by training on the general charging information database.

An embodiment of the present disclosure may achieve the advantage of providing driving guidance information that enables comfortable driving by considering the remaining battery charge level of an electric vehicle.

An embodiment of the present disclosure may achieve the advantage of providing driving guidance information appropriate to a situation by determining a target remaining battery charge level in accordance with the situation based on the usage of the internal and external information of an electric vehicle.

An embodiment of the present disclosure may achieve the advantage of providing driver-customized driving guidance information by determining a target remaining battery charge level based on the consideration of a driver's tendencies.

An embodiment of the present disclosure may achieve the advantage of providing driving guidance information appropriate to a situation even when driver information is not sufficiently accumulated.

Various advantages that may be directly or indirectly understood by those skilled in the art may be provided throughout the present specification.

Although the present disclosure has been described with reference to the example embodiments, those skilled in the art may variously modify and change an embodiment of the present disclosure without departing from the spirit and scopes of the present disclosure described in the attached claims.

The control device may be at least one microprocessor operated by a predetermined program that may include a series of commands for carrying out the method included in the aforementioned various example embodiments of the present disclosure.

In various example embodiments of the present disclosure, each operation described above may be performed by a control device, and the control device may be configured by a plurality of control devices, or an integrated single control device.

In various example embodiments of the present disclosure, the memory and the processor may be provided as one chip, or provided as separate chips.

In various example embodiments of the present disclosure, the scope of the present disclosure can include software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various example embodiments of the present disclosure, the control device may be implemented in a form of hardware or software, or may be implemented in a combination of hardware and software.

The terms such as “unit,” “module,” etc. included in the specification can be units for processing at least one function or operation, which may be implemented by hardware, software, or a combination thereof.

In an example embodiment of the present disclosure, the vehicle may be referred to as being based on a concept including various transportation systems. In some cases, the vehicle may be interpreted as being based on a concept including not only various land transportation systems, such as cars, motorcycles, trucks, and buses, that drive on roads but also various transportation systems such as airplanes, drones, ships, etc.

For convenience in explanation and accurate definition in the appended claims, the terms “upper,” “lower,” “inner,” “outer,” “up,” “down,” “upwards,” “downwards,” “front,” “rear,” “back,” “inside,” “outside,” “inwardly,” “outwardly,” “interior,” “exterior,” “internal,” “external,” “forwards,” and “backwards” can be used to describe features of the example embodiments with reference to the positions of such features as displayed in the figures. It can be further understood that the term “connect” or its derivatives can refer both to direct and indirect connection.

The term “and/or” may include a combination of a plurality of related listed items or any of a plurality of related listed items. For example, “A and/or B” can include all three cases such as “A,” “B,” and “A and B.”

In the present specification, unless stated otherwise, a singular expression can include a plural expression unless the context clearly indicates otherwise.

In example embodiments of the present disclosure, “at least one of A and B” may refer to “at least one of A or B” or “at least one of combinations of at least one of A and B.” Furthermore, “one or more of A and B” may refer to “one or more of A or B” or “one or more of combinations of one or more of A and B.”

In the example embodiment of the present disclosure, it can be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific example embodiments of the present disclosure have been presented for purposes of illustration and description. They are not intended to be exhaustive or to necessarily limit the present disclosure to the precise forms disclosed, and many modifications and variations can be possible in light of the above teachings. The example embodiments were chosen and described to explain certain principles of the present disclosure and practical applications, to enable others skilled in the art to make and utilize various example embodiments of the present disclosure, as well as various alternatives and modifications thereof. It is intended that the scopes of the present disclosure be defined by the Claims appended hereto and their equivalents.

What is claimed is:

1. A driving information display apparatus comprising:
one or more processors; and
a storage medium configured to store road information and an algorithm configured to be run by the one or more processors, and storing computer-readable instructions that, when executed by the one or more processors, enable the one or more processors to:
perform control to receive driving guidance information and location information of an electric vehicle, and
output a guidance screen corresponding to the driving guidance information, wherein the driving guidance information includes charging guidance information intended to prevent a battery charge level of the electric vehicle from being lower than a target remaining battery charge level generated based on internal and external state information of the electric vehicle and current-driver information related to a current driver.

2. The apparatus of claim 1, wherein the target remaining battery charge level is generated based on per-driver-artificial-intelligence-model information obtained by entering the internal and external state information into a per-driver artificial intelligence model that is generated by training on a driver charging information database that records the internal and external state information and an amount of electricity charged whenever the current driver previously charged the electric vehicle in a first past period of time.

3. The apparatus of claim 2, wherein, in response to that the per-driver artificial intelligence model has not been generated for the current driver, the target remaining battery charge level is generated based on general-artificial-intelligence-model information obtained by entering the internal and external state information into a general artificial intelligence model that is generated by training on a general charging information database that records the internal and external state information and the amount of electricity charged whenever each of a large set of drivers previously charged their electric vehicles in a second past period of time.

4. The apparatus of claim 1, wherein the internal and external state information includes one of or any combination of:
a normalized value of a number of charging stations within a predetermined distance from a destination;
current-driver-fatigue information related to a fatigue level of the current driver generated based on an image from an internal camera of the electric vehicle;
preferred-charging-station information related to a preferred charging station generated based on brand information of a set of previously-used charging stations previously used by the current driver of the electric vehicle;
incident-facilities information related to incident facilities of a given charging station generated based on whether the incident facilities of the given charging station were previously used by the current driver of the electric vehicle; and
weather information.

5. A driving information management server comprising:
one or more processors; and
a storage medium configured to store computer-readable instructions that, when executed by the one or more processors, enable the one or more processors to:
set up connections to exchange information with driving information display apparatuses of a plurality of electric vehicles;
receive internal and external state information and current-driver information of each of the plurality of electric vehicles; and
obtain a target remaining battery charge level for a given electric vehicle of the plurality of electric vehicles, based on the internal and external state information and the current-driver information of the plurality of electric vehicles, and transmit charging guidance information, generated using the target remaining battery charge level, to the given electric vehicle.

6. The server of claim 5, wherein the instructions further enable the one or more processors to:
in response to the given electric vehicle being charged, receive and store the internal and external state information and the current-driver information of the given electric vehicle in a driver charging information database for each given driver; and
obtain the target remaining battery charge level based on per-driver-artificial-intelligence-model information obtained by entering the internal and external state information into a per-driver artificial intelligence model that is generated by training on the current-driver information of the driver charging information database corresponding to a current driver.

7. The server of claim 6, wherein the instructions further enable the one or more processors to:
store the internal and external state information and the current-driver information in a general charging information database that stores the internal and external state information and the current-driver information of a large set of drivers in an integrated manner; and
in response to that the per-driver artificial intelligence model has not been generated for the current driver, obtain the target remaining battery charge level based on general-artificial-intelligence-model information obtained by entering the internal and external state information of the current driver into a general artificial intelligence model that is generated by training on the general charging information database.

8. A driving information display method, the method comprising:
generating a target remaining battery charge level of an electric vehicle based on internal and external state information of the electric vehicle and current-driver information related to a current driver;
generating charging guidance information intended to prevent a battery charge level of the electric vehicle from being lower than the generated target remaining battery charge level; and
displaying driving information including the generated charging guidance information.

9. The method of claim 8, wherein the generating of the target remaining battery charge level is based on per-driver-artificial-intelligence-model information obtained by entering the internal and external state information into a per-driver artificial intelligence model generated by training on a driver charging information database that records the internal and external state information and an amount of electricity charged whenever the current driver previously charged the electric vehicle in a first past period of time.

10. The method of claim 9, wherein, in response to that the per-driver artificial intelligence model has not been generated for the current driver, the generating of the target remaining battery charge level is based on general-artificial-intelligence-model information obtained by entering the internal and external state information into a general artificial intelligence model generated by training on a general charging information database that records the internal and external state information and amounts of electricity charged whenever each of a large set of drivers previously charged their electric vehicle in a second past period of time.

11. The method of claim 8, wherein the internal and external state information includes one of or any combination of:
a normalized value of a number of charging stations within a predetermined distance from a destination;
current-driver-fatigue information related to a fatigue of the current driver generated based on an image from an internal camera of the electric vehicle;
preferred-charging-station information related to a preferred charging station generated based on brand information of a set of previously-used charging stations previously used by the current driver of the electric vehicle;
incident-facilities information related to incident facilities of a given charging station generated based on whether the incident facilities of the given charging station were previously used by the current driver of the electric vehicle; and
weather information.

12. A non-transitory computer-readable storage medium having stored thereon a program that, when executed by a processor, causes the processor to execute the driving information display method of claim 8.
